(19) United States
(12) Patent Application Publication
(10) Pub. No.: US 2022/0318331 A1
(43) Pub. Date: Oct. 6, 2022

(54) AUGMENTED SEARCH SYSTEM AND METHOD

(71) Applicant: Avatria Inc., Chicago, IL (US)

(72) Inventors: Zachary McMahon, Chicago, IL (US); Hardik J. Thakkar, Chicago, IL (US)

(21) Appl. No.: 17/221,499

(22) Filed: Apr. 2, 2021

(51) Int. Cl. G06F 16/9538; G06N 20/00

(52) U.S. Cl. CPC G06F 16/9538; G06N 20/00

(57) ABSTRACT

Methods and systems are described for providing an augmented search system. A search query is received, and an initial set of search results is determined, ranked in a first order. An artificial intelligence model is selected based on a desired goal. The search query, analytics data corresponding to the user, and the initial search results are applied to the selected artificial intelligence model, to determine a re-ranked set of search results, ranked in a second order. The re-ranked search results are provided to the user.

### TECHNICAL FIELD

This disclosure relates to a system and method for feature-based customization and optimization of web-based search results outputted for a user. The systems and methods disclosed herein are designed to be applied to existing search engines and web platforms without replacing the existing search engines and web platforms, and to provide a user-friendly output for use in a variety of contexts.

### BACKGROUND

Search engines for websites display various outputs and information accessible to a user viewing that website. The search engine in this context may provide results that may be curated or selected from a database based on a user's search query. The outputted results may be ranked based on relevance to the search query to provide the user with more meaningful results than simply providing a list in alphabetical order or some other default order.

With the general trend toward increased personalization, there is an opportunity for systems and methods that provide personalized search results that differ from user to user. There is also an opportunity to provide systems and methods that produce personalized search results without requiring a complete overhaul or replacement of an existing search engine or platform.

### SUMMARY

Embodiments of the present disclosure provide at least three benefits or aspects which address the needs of the industry noted above.

In a first respect, the system and method of the present disclosure generates a customizable, feature-based model to output and/or display search results for a website. Websites may include e-commerce websites, video websites, recipe sites, real estate listing, or any other suitable website that lists, outputs or displays results (i.e., lists of products, services, articles, media, or other items) that need to be ranked for a user to browse and/or select. Typical models used for websites take inputs and make predictions on the input to prioritize outputs for the end users. Example embodiments of the system and method of the present disclosure generate models using data collected from machine learning and/or artificial intelligence (“AI”), user data such as browsing and/or shopping behavior data from the websites, and the opportunity to incorporate custom data from the website owner. The system and method of the present disclosure utilizes the collected data to define specific features and generate models based on the defined features to accomplish specific output goals defined by the website owner. Such feature-based models may be used to optimize search results returned when a search query is performed based on the defined goals. For example, an ecommerce site owner may wish to increase the overall purchases made by users by presenting the users with items likely to be selected by the specific user. In this example, the systems and methods disclosed herein may enable this goal by outputting search results that have been re-ranked to prioritize items that are more likely to be purchased by each given user. In still other examples, the search results, after being re-ranked based on a first desired goal, may further be displayed to the user in a particular manner aimed at meeting the additional desired goals, such as for example, prioritizing items with the greatest inventory as well. While this example, and other examples included herein, relates to ranking of products of an ecommerce website, it should be appreciated that the features and examples disclosed herein may also or alternatively apply to services, articles, media, or other items that may be provided to a user in response to the user entering a search query. For instance, features disclosed herein may apply to a news website in order to provide a re-ranked list of relevant news articles to a user.

In a second respect, embodiments of the present disclosure may also be configured to provide the improved search results in a package or system that can be easily incorporated into an existing search engine or web platform. Existing systems that attempt to provide improved search results typically require completely replacing a search engine with an updated or different search engine that is configured to provide specific search results beyond a default ranking. The present disclosure includes examples of systems and methods that can be added on top of or in addition to an existing search engine or web platform, and can be applied to many different search engines regardless of the specific code or algorithms used. In this manner, embodiments of the present disclosure may provide a system which is search engine- or web platform-agnostic, and can be easily incorporated into an existing framework.

In a third respect, embodiments of the present disclosure provide an improved output and user interface over existing solutions, and enable greater flexibility in operation and the use of analytical data for various purposes such as marketing.

An example method for providing improved search results includes receiving, at a web platform, a search query from a user. The method also includes, determining, by the web platform based on the search query, an initial set of search results ranked in a first order. The method further includes receiving analytics data corresponding to the user. The method still further includes determining, based on a desired goal of the web platform, a target artificial intelligence model from a plurality of available artificial intelligence models. The method yet further includes applying the target artificial intelligence model to the search query, initial set of search results, and the analytics data to determine a re-ranked set of search results, ranked in a second order; and providing the re-ranked set of search results, ranked in the second order, to the user.

An example system for providing improved search results includes a web platform configured to: receive, from a user device, a search query; determine, based on the search query, an initial set of search results ranked in a first order; receive, from an augmented search system, a re-ranked set of search results; and provide, to the user device, the re-ranked set of search results. The system also includes an augmented search system configured to: receive, from the web platform, the search query and the initial set of search results; receive analytics data corresponding to the user device; determine, based on a desired goal of the web platform, a target artificial intelligence model from a plurality of available artificial intelligence models; apply the target artificial intelligence model to the search query, initial set of search results, and the analytics data to determine the re-ranked set of search results, ranked in a second order; and provide, to the web platform, the re-ranked set of search results, ranked in the second order.

An example computer-readable medium has instructions stored thereon that, when executed by a processor, cause the performance of a set of acts. The set of acts includes: receiving a search query from a user; determining, based on the search query, an initial set of search results ranked in a first order; receiving analytics data corresponding to the user; determining, based on a desired goal, a target artificial intelligence model from a plurality of available artificial intelligence models; applying the target artificial intelligence model to the search query, initial set of search results, and the analytics data to determine a re-ranked set of search results, ranked in a second order; and providing the re-ranked set of search results, ranked in the second order, to the user.

These and other aspects will become readily apparent from the written specification, drawings, and claims provided herein.

### BRIEF DESCRIPTION OF DRAWINGS

FIG. 1 is a schematic diagram of an exemplary computing device capable of supporting and facilitating one or more aspects described herein.

FIG. 2 illustrates an example system in which embodiments of the present disclosure may operate.

FIG. 3 illustrates an example method according to embodiments of the present disclosure.

FIG. 4 illustrates an example simplified block diagram of the system of the present disclosure integrated with an existing web platform using a plugin technique.

FIG. 5 illustrates an example simplified block diagram of the system of the present disclosure integrated with an existing web platform using a reverse proxy technique.

### DETAILED DESCRIPTION OF EXEMPLARY EMBODIMENTS

The description that follows describes, illustrates and exemplifies one or more particular embodiments of the invention(s) in accordance with its principles. This description is not provided to limit the invention(s) to the embodiments described herein, but rather to explain and teach the principles of the invention(s) in such a way to enable one of ordinary skill in the art to understand these principles and, with that understanding, be able to apply them to practice not only the embodiments described herein, but also other embodiments that may come to mind in accordance with these principles. The scope of the invention(s) is/are intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates the didactic purpose of the specification. Additionally, the drawings set forth herein are not necessarily drawn to scale, and in some instances proportions may have been exaggerated to more clearly depict certain features. Such labeling and drawing practices do not necessarily implicate an underlying substantive purpose. Furthermore, one or more drawings herein may be of a purely functional schematic nature, or a combination of a functional and structural/hardware schematic nature, intended to disclose and teach functional aspects of the subject matter without necessarily limiting the disclosure to any specific structure/hardware. As stated above, the present specification is intended to be taken as a whole and interpreted in accordance with the principles of the invention(s) as taught herein and understood to one of ordinary skill in the art.

With respect to the exemplary systems, components and architecture described and illustrated herein, it should also be understood that the invention(s) may be embodied by, or employed in, numerous configurations and components, including one or more system, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system. Furthermore, although one or more systems, devices, apparatuses, and other components may be described, all methods, systems, and articles of manufacture consistent with known architecture for these components are intended to be encompassed. For example, a processor may be implemented as part of one or more components as a microprocessor, microcontroller, application specific integrated circuit (ASIC), discrete logic, or a combination of other type of circuits or logic. Similarly, memories as part of one or more of these components may be DRAM, SRAM, Flash or any other type of memory. Flags, data, databases, tables, and other data structures may be separately stored and managed, may be incorporated into a single memory or database, may be distributed, or may be logically and physically organized in many different ways. Software programs, which may be described in terms of one or more code segments, may be parts of a single program, separate programs, or distributed across several memories and processors. The methods and functionality described herein may be implemented via hardware, software, and/or firmware, and processed by one or more processor-based systems, components or devices. Such methods and functionality may be described as a module or engine with the understanding that its implementation is not limited to any particular hardware, software, firmware, or device configuration, but rather encompassing all implementations/embodiments within the skill of one of ordinary skill in the art. Systems may be implemented in hardware, software, or a combination of hardware and software in one processing system or distributed across multiple processing systems. Accordingly, the invention(s) should not be construed as limited by the exemplary embodiments described herein or any of the associated didactic schematics.

### Computing System

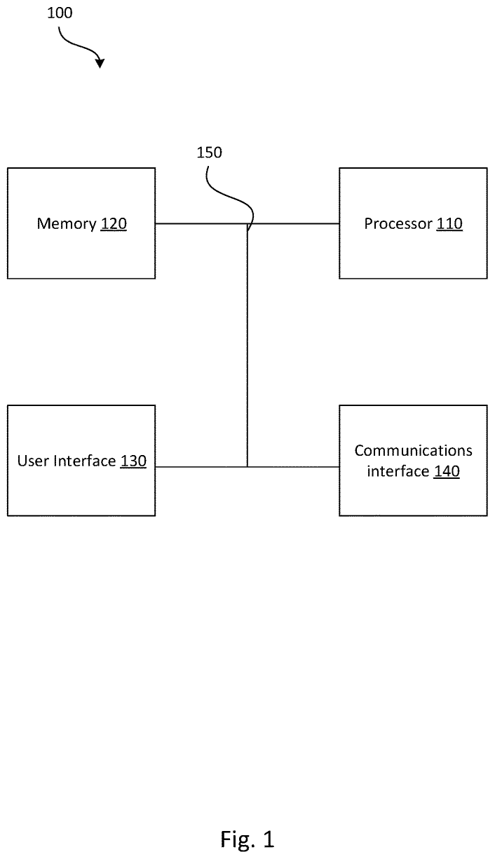

FIG. 1 illustrates a simplified block diagram of an example computing device 100 according to embodiments of the present disclosure. Computing device 100 may be configured for performing a variety of functions or acts, such as those described in this disclosure (and accompanying drawings). The computing device 100 may include various components, including for example, a processor 110, memory 120, user interface 130, and communication interface 140, all communicatively coupled by system bus, network, or other connection mechanism 150. It should be understood that examples disclosed herein may refer to computing devices and/or systems having components that may or may not be physically located in proximity to each other. Certain embodiments may take the form of cloud based systems or devices, and the term “computing device” should be understood to include distributed systems and devices (such as those based on the cloud), as well as software, firmware, and other components configured to carry out one or more of the functions described herein.

Processor 110 may include a general purpose processor (e.g., a microprocessor) and/or a special purpose processor (e.g., a digital signal processor (DSP)). Processor 110 may be any custom made or commercially available processor, such as, for example, a Core series or vPro processor made by Intel Corporation, or a Phenom, Athlon or Sempron processor made by Advanced Micro Devices, Inc. In the case where the computing device 100 is a server, the processor 110 may be, for example, a Xeon or Itanium processor from Intel, or an Opteron-series processor from Advanced Micro Devices, Inc. Processor 110 may also represent multiple parallel or distributed processors working in unison.

Memory 120 may include one or more volatile (e.g., random access memory (RAM, such as DRAM, SRAM, SDRAM, etc.)) and nonvolatile (e.g., ROM, hard drive, flash drive, CDROM, etc.), removable, and/or non-removable storage components, such as magnetic, optical, or flash storage, and may be integrated in whole or in part with the processor 110. These and other components may reside on devices located elsewhere on a network or in a cloud arrangement. Further, the memory 120 may take the form of a non-transitory computer-readable storage medium, having stored thereon program instructions (e.g., compiled or non-compiled program logic and/or machine code) that, when executed by the processor 110, cause the device 100 to perform one or more functions or acts, such as those described in this disclosure. Such program instructions may define or be part of a discrete software application that can be executed in response to certain inputs received from the user interface 130 and/or communication interface 140, for instance. Memory 120 may also store other types of information or data, such as those types described throughout this disclosure.

User interface 130 may facilitate interaction with a user of the device, if applicable. As such, user interface 130 may include input components such as a keyboard, a keypad, a mouse, a touch-sensitive panel, a microphone, and a camera, and output components such as a display screen (which, for example, may be combined with a touch-sensitive panel), a sound speaker, and a haptic feedback system. The user interface 130 may also comprise devices that communicate with inputs or outputs, such as a short-range transceiver (RFID, Bluetooth, etc.), a telephonic interface, a cellular communication port, a router, or other types of network communication equipment. The user interface 130 may be internal to the computing device 200, or may be external and connected wirelessly or via connection cable, such as through a universal serial bus port.

Communication interface 140 may be configured to allow the device 100 to communicate with one or more devices (or systems) according to one or more protocols. In one example, the communication interface 140 may be a wired interface, such as an Ethernet interface or a high-definition serial-digital-interface (HD-SDI). As another example, the communication interface 140 may be a wireless interface, such as a cellular or WI-FI interface. In some examples, each of a plurality of computing devices 100 and/or other devices or systems on a network may be configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while some embodiments may include computing device 100 having a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

In the context of this document, a “computer-readable medium” may be any means that can store, communicate, propagate, or transport data objects for use by or in connection with the systems and methods as described herein. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The systems, devices, and methods can be embodied in any type of computer-readable medium for use by or in connection with an instruction execution system or apparatus, such as a computer.

### Feature-Based Model Development

In one example, the system and method of the present disclosure generates a customizable, feature-based model to display search results for a user of a website. This may be, for example, an ecommerce site that allows users to purchase goods, a website to obtain media services (i.e., videos, music, literature), recipe websites, real estate listings, or any other website that lists, outputs, or displays search results that are ranked for a user to browse and/or select. Typical models used for websites may take inputs from users and make predictions on the inputs to prioritize outputs for those users.

The systems, devices, and methods described herein generate a customizable, feature-based model to output and/or display search results for a website. In one embodiment, the system, devices and methods of the present disclosure receive input data from the website owner's existing analytics platform. In certain embodiments, additional or alternative analytics sources may also be incorporated into the analysis of the system and method of the present disclosure. The system and method of the present disclosure, includes developing a feature-based model that utilizes the input data to determine what ranking to pass back to the search engine based on the search query and other inputs received. In one example, a user may input via his or her computer a search query for a certain product category (e.g., shoes). The query may be passed to the search engine of the web platform (in this example, an ecommerce platform), which in turn may generate a list of relevant results. The augmented search system of the present disclosure performs an analysis on the generated list of results to re-rank the results based on one or more specific factors or attributes that are assigned, and based on one or more goals defined by the owner of the web platform. For instance, an ecommerce platform may have a goal to increase sales of items that have a high inventory nearby the user (such as results that are located proximate to the user's specified location). The augmented search system may take into account, for example, the search query input by the user, the location of the user, product information from the web platform, interaction data (e.g., behavior related to the input search query such as which pages other users view for that search query, which products do other users click on, which products do other users add to their carts, etc.), and the goal of the web platform to increase sales of the specific high inventory item(s), in order to prioritize certain products or re-rank certain products above where they would otherwise be. In this manner, the web platform's goal of reducing inventory of the specific high inventory items may be furthered, while still providing the user with personalized results. This is merely one example, and many other examples and variations are possible, some of which are described below.

The system and method of the present disclosure has the additional benefit that it can be easily integrated on top of, or in addition to, the existing platform of a web platform. Various embodiments of the system and method of the present disclosure also provide an improved output and user interface over existing solutions, and enable greater flexibility in operation and the use of analytical data for various purposes such as marketing.

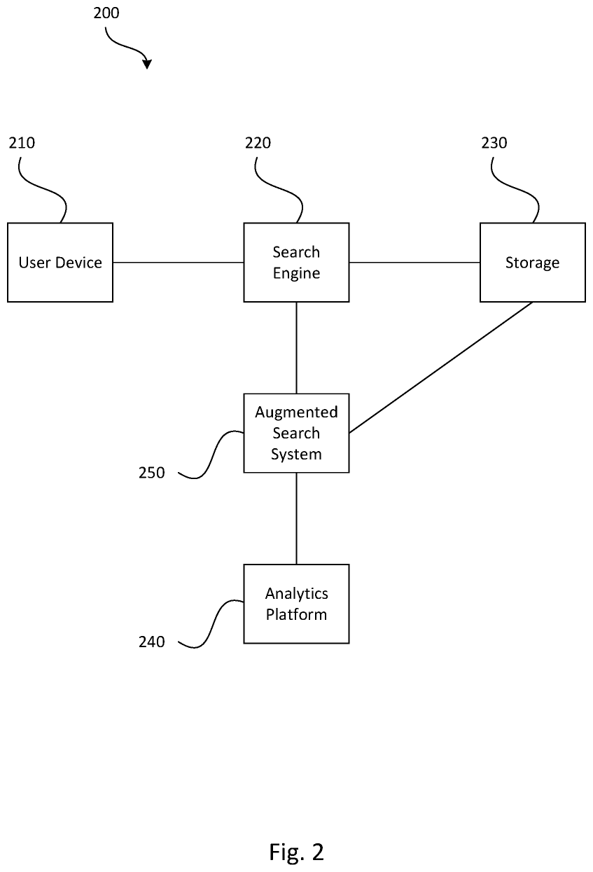

FIG. 2 illustrates an example environment or system 200 in which embodiments of the present disclosure may operate. The example system 200 includes a user device 210, a search engine 220, a storage 230, an analytics platform 240, and an augmented search system 250. Each of these components may be a computing device (such as computing device 100), and/or may be a part of a larger distributed computing device or system. For instance, the search engine 220 and the storage 230 may comprise a single computing device or set of networked computing devices. It should also be appreciated that each of these components may comprise multiple computing devices, which may be communicatively coupled to each other.

The user device 210 may comprise any device accessible by a user for the purpose of inputting a search query and receiving corresponding results. For example, the user device 210 may comprise a laptop, desktop computer, phone, tablet computer, and more. The user device 210 may be configured to store user information, such as a user ID, account, user name, email address, or other identifying information. The user device 210 may also be configured to gather and/or store biographical and/or geographical information corresponding to one or more users, such as an age, gender, birthday, location, weather, calendar information, contacts or other associated users, and more. The user device 210 may also be configured to receive a search query from the user, which may comprise text, symbols, images, sounds (i.e., voice input) or other information. This search query may be passed to the search engine 220 via a communication channel between the user device 210 and the search engine 220 (e.g., via the internet).

The search engine 220 may be part of the web platform, and/or may be operated as part of a server or other computing system. The search engine 220 may be configured to receive the search query, and parse the search query using one or more algorithms in order to assist with determining relevant search results. In addition to receiving the search query, the search engine 220 may be configured to receive user identification information (and/or other user information such as that noted above) from the user device 210.

The search engine 220 may further retrieve user information from the storage 230. In one example, the user device 210 may pass the search query along with a user ID to the search engine 220. The search engine 220 may search and retrieve data related to the user ID (e.g., a user account) from the storage 230. The search engine may also retrieve, from the storage 230, product information related to various products that may be passed back as search results to the user device 210. The set of products and/or product information retrieved from the storage 230 may be determined based on any suitable method or algorithm.

In some examples, the list of products retrieved from the storage 230 may be passed back to the user device 210 as the search results for the input search query.

Alternatively, when the augmented search system 250 is engaged, the list of products retrieved by the search engine 220 (i.e., the search results) may be passed to the augmented search system 250, in addition to the search query and any relevant user information. The augmented search system may then re-rank the list based on the received information, and pass the re-ranked list back to the search engine. It should be appreciated that in certain embodiments, the augmented search system may also add or remove items to the re-ranked search results list. In other words, the received re-ranking is not limited to items provided by the search engine. The re-ranked list may then be passed back to the user device 210 for display to the user.

The storage 230 may be a part of the ecommerce platform, and/or may be operated as part of a server or other computing system. The storage 230 may be configured to store various information specific to the user, as well as information specific to the products available to be returned as search results to the user device 210.

In certain example systems, the user information stored may include a user account information associated with the user, as well as historical and current interactions by the user with the website or web platform. For example, the storage 230 may include past purchases (e.g., items purchased, date of purchase, etc.).

The storage 230 may also store information associated with various products offered by the web platform, such as those products that may be returned as search results to the user when a search query is entered. The product information may include product financial information, such as product price, profit margin, manufacturing costs, discounts, current, past, or future sales prices, and more. The product information may also include inventory related information, such as the date a product was first made available for purchase, a remaining inventory, expected restocking date of inventory, lead time required to restock, the physical location of items that are in stock, the distance between the nearest in stock item and the user location, and more. Product information may further include physical characteristics of the products such as the size, shape, weight, color, available features, and more. Product information may further include other information related to various products such as recent or historical purchase figures, product popularity metrics, the timing of past, current, or future sales, secondary items paired with or often purchased with a given item, cyclical trends (e.g. summer vs. winter products), and other customizable attributes as defined by the web platform. It should be appreciated that the examples of product information provided here are not limiting, and that many more metrics and values may be stored and used for the various purposes disclosed herein.

The storage 230 may also store one or more indices that are used to retrieve lists of products based on a given search query.

The analytics platform 240 may comprise one or more devices or systems configured to store information related to the user of the user device 210. For instance, the analytics platform 240 may comprise a server or set of networked servers that collect and/or store user information from a variety of sources, and from a variety of interactions of the user over time. Example analytics platforms may include Google Analytics and Adobe analytics, however it should be appreciated that other analytics platforms may be used as well.

In particular, the analytics platform 240 may be separate from either Google Analytics and/or Adobe Analytics, and may be customized for use in connection with the system disclosed herein. The analytics platform 240 may be used to collect customer behavior and other types of event and interaction data. This information may be collected by the analytics platform 240 by using javascript tags or code installed on the web platform site that can capture all of the relevant information and send it back to the analytics platform 240. By using a specifically tailored analytics platform, as opposed to Google Analytics or Adobe Analytics, the analytics platform 240 may include added functionality, may be able to adapt and evolve to support the new functionality (particularly from a data collection perspective), and may be better integrated with the rest of the system. Furthermore, a specifically tailored analytics platform 240 may not be constrained by the limitations of Google Analytics, Adobe Analytics, or other analytics platforms. For instance, these analytics platforms may include tagging limitations, and/or pricing and functionality changes over time. A specifically tailored analytics platform also enables future upgrades and development, such as improvements to reporting, analysis, and automated insight capabilities that are not available in current analytics platforms such as Google Analytics and Adobe Analytics.

In certain embodiments, the analytics platform 240 may further store custom data to be incorporated into the system and method disclosed herein. Embodiments of the present disclosure may also incorporate custom data provided by the website owner for further personalization (such as custom data that is stored in the storage 230). Furthermore, the custom data may come from any suitable source, not only the analytics platform 240 and/or the storage 230, but any other system, both internal or external. This includes business-specific data that may not be collected by the external analytics platform. For example, the custom data may include business-specific data such as vehicle data for an automotive website, location-specific data for a multi-location business, product cost or margin information, current weather at the user's location, and more.

The stored analytics information may include the user's history and interaction with one or more websites or platforms, both during a current browsing session and during previous browsing sessions. For instance, the analytics platform 240 may keep track of the user's activity during a current browsing session with the web platform, as well as an historical record of previous browsing sessions with the web platform. This information can include the pages visited by the user; past search queries, products or pages viewed by the user, products added to a shopping cart, which products or pages were clicked on, past purchases by the user, the time, date, and location of the user during current or previous interaction with the web platform, and any other information that could be considered an interaction or relevant to an interaction with the web platform. The analytics information may also include the existence and activity related to a user account of the user with a different website or service, such as an email account, social media account, photo sharing service, and more. The analytics information may further or alternatively include metrics related to other users, such as general trends for the group of users sharing similar biographical information (e.g., similar age, gender, location, etc.). The analytics information may further include data related to user affinity, such as user preference for certain product brands, particular color schemes, preference for certain materials, frequency of purchasing certain product categories, and other information collectable regarding the user.

Various embodiments of the present disclosure include an augmented search system 250 that is configured to receive information relevant for determining the feature-based model displaying search results. In some examples, the augmented search system may be called a “Relevance Engine.” At a high level, the augmented search system 250 is configured to determine what rankings need to be passed back to the search engine 220 based on various received information. Examples of received information include, but are not limited to, the search query input by the user, the search results found by the search engine 220, the user information stored in the storage 230, the product information stored in the storage 230, and the analytics information from the analytics platform 240. In some examples, information from the analytics platform 240 may be accessed via an Application Programming Interface (“API”) of the analytics platform 240.

In some examples, the augmented search system 250 may also access the stored custom data provided by the business owner. Existing ranking systems may be restricted to data obtained from external analytics platforms. Embodiments of the present disclosure may also access owner-based custom data stored in the analytics platform in addition to, or instead of, the external analytics data. For example, the augmented search system may access custom data such as the make, model, and year information for a user's vehicle. This information may be incorporated into the model and/or the final rankings of the search results for a tire selling web site, so as to avoid providing a high ranking for a tire that does not fit the user's vehicle. The model may incorporate this “custom data.” However where the model does not incorporate the custom data, the augmented search system may make use of the custom data before or after the search results have been re-ranked in order to provide more appropriate re-ranked search results.

The augmented search system 250 of the present disclosure allows for customized feature-based models to be created without requiring the implementation of an additional analytics tagging solution. The web platform may begin using the system easily, without needing to perform a custom tagging for even basic functionality. The system may operate using one or more defaults, which may be changed or customized later.

In certain embodiments, the augmented search system 250 may be a part of the web platform, and/or may be operated as part of a server or other computing system that is communicatively coupled to the web platform. The augmented search system 250 may include storage (e.g., a separate storage from storage 230), which may include the “custom data” noted above.

In some examples, the augmented search system 250 may be configured to automatically determine the specific AI model or machine learning algorithm to be used, based at least in part on a desired goal of the web platform. The augmented search system 250 may also be configured to determine the specific model parameters (e.g., ranking override rules, query targeting rules, model training schedule, etc.) that will impact the final rankings of the search results.

The model generated by the system and method of the present disclosure is customizable based on features designed to achieve defined goals of the web platform. The goals may include objectives sought by the web platform, including financial objectives, such as increasing total purchase price per user per session, increasing purchases, increasing the number of items purchased, increasing overall margin, and increasing overall revenue. Additionally, goals may be based on inventory, such as increasing the number of purchases of one or more items, decreasing the inventory of one or more items, and increasing the sales of a low inventory item. Other examples of goals may be based on location, increasing shipping efficiency; increasing user satisfaction with purchased items (i.e., increasing the likelihood of the user leaving a positive review); increasing traffic to a selected product or set of products' information page; increasing time spent on a selected product or set of product's information page; increasing overall time spent on the website by the user more generally; and/or decreasing the number and duration for which products are left in a shopping cart without being purchased. It should be appreciated that these are merely examples, and that additional or different goals and variations of the goals disclosed herein may be used.

Based on the goals defined by the ecommerce platform, the system and method of the present disclosure defines specific features to be used to re-rank the search results generated in the model and displayed to the user. More specifically, the augmented search system 250 may use the stored user information, product information, analytics information, custom data, and web platform defined goals that it receives to re-rank the search results provided by the search engine 220. The re-ranked results may be determined based on machine learning and/or an artificial intelligence used to develop models. For example, a model may be developed based around the goal of increasing overall sales. The model may be “trained” using information from many users over a long period of time, to tailor the model for the specific goal of increasing overall sales. The trained model may then be executed on the input search query (and various other information as noted herein) to output the re-ranked search results that have been optimized for the goal of increasing overall sales.

The re-ranked results may then be passed back to the search engine 220, and forwarded on to the user device 210. In some examples, the augmented search system 250 may also provide information used to display particular results for the particular user.

In certain example embodiments, the augmented search system 250 may remove one or more search results, and/or add one or more search results during the process of re-ranking.

In certain example embodiments, the augmented search system 250 may be configured to dictate which information is used and which is not, in determining the re-ranked results. For example, the user and/or web platform may have an option for the user to opt out of certain information be used (e.g., the system cannot use location information or website activity information).

In some examples, there may be a default goal selected. In other examples, the web platform may be able to input a particular goal. In still other examples, two or more goals may both be selected, with one goal prioritized over the other goal(s). In some examples where multiple goals are selected, the goal prioritization may function based on a simple priority (e.g., primary goal secondary goal, etc.), or based on a weighting of the goals (e.g., 60% weight to first goal, 40% weight to second goal). Furthermore, this functionality may be flexible or customizable. For instance, the order of goals and weighting of goals may be changed based on the user, based on the search query, and/or based on some other factor or condition that may be considered.

### System Integration

The design and/or architecture of the system of the present disclosure also enables the system to integrate and/or operate with any search engine, web platform, or ecommerce platform. Existing tools that rank search results for websites may include certain tools that may add functionality to existing search engines, but provide limited additional functionality. Still other existing tools may provide greater functionality regarding the ranking of search results, but may require a given web platform to completely replace the existing search engine or customer environment.

The disclosed augmented search system builds on the existing framework of a web platform by integrating information from the user device, web platform storage, and analytics platform, to insert a set of re-ranked results into the existing stream of the web platform. Embodiments of the present disclosure enable the ecommerce platform to maintain its current search engine, while augmenting the ability of the search engine to provide specific tailored results to meet particular ecommerce platform goals.

In some examples of the system and method of the present disclosure, integration is accomplished by use of APIs for the various components of the system. For instance, the analytics platform may be accessed via an API. By accessing the existing analytics platform of the web platform using an API, operation of the disclosed system does not require that a brand new analytics platform be installed and used. Rather, the existing framework of the web platform can be tapped into to gather the relevant information from the existing analytics platform. Similarly, the various machine learning and AI models, and the augmented search system (or “Relevance Engine”) are made accessible via an API. This enables the models and augmented search system to be stored on the cloud, or stored within the web platform environment, thereby providing another point of flexibility in integration with the existing web platform. In examples where the analytics platform is a specifically tailored analytics platform, and/or is not Google Analytics or Adobe Analytics (e.g., not an existing platform), the integration may be even easier. The analytics platform in these cases may be developed specifically for easy integration with the rest of the system.

In some examples, the system may also include a plugin that is used to broker communication between the search engine 220 and the augmented search system 250. The plugin may be specific to a particular search engine (e.g., Solr, Shopify, Magento, BigCommerce, etc.). Different plugins may be developed specifically for each different search engine, to allow the augmented search system 250 to communicate with any given search engine used by the web platform. The use of a plugin simplifies installation of the system by the web platform. The web platform may be required only to install the plugin, and is not required to replace the search engine, storage system, or other component of the web platform infrastructure. If a given web platform does not include a search engine for which a plugin has been developed (i.e., a custom search engine or other search engine), the augmented search system can be accessed via an API.

In another embodiment of the present disclosure, the system integration is employed by a reverse proxy implementation approach. The embodiments disclosed above have been generally disclosed with the arrangement that includes a search engine receiving a search query, generating search results, passing those search results to the augmented search system, and then the augmented search system passing re-ranked search results back to the search engine for subsequent passing of the re-ranked search results back to the user. In some example embodiments implementing the reverse proxy approach, the augmented search system may operate as a “middleman” or reverse proxy server that fields search requests from the web platform and passes them off to the search engine, allowing the augmented search system to adjust the rankings for any search results where it is enabled. This approach allows for integration with the web platform's systems and requires no code modification of the underlying web platform.

### Example Methods

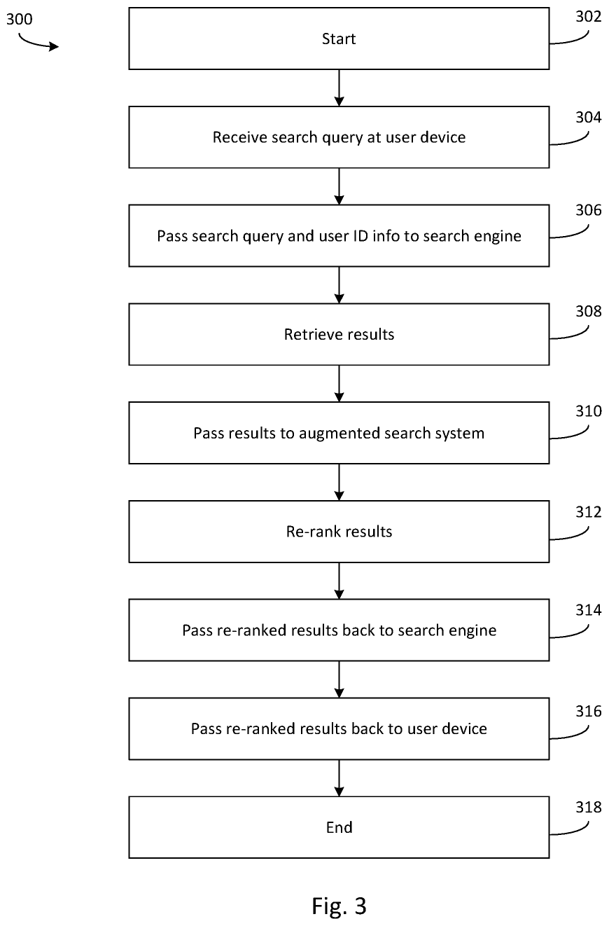

FIG. 3 illustrates an example method 300 according to embodiments of the present disclosure. Method 300 may be performed by one or more computing devices or systems, such as computing device 100 described with respect to FIG. 1. The flowchart of FIG. 3 is representative of machine readable instructions that are stored in memory (such as memory 120 of computing device 100) and may include one or more programs which, when executed by a processor (such as processor 110 of computing device 100) may cause one or more systems or devices to carry out one or more functions described herein. While the example program is described with reference to the flowchart illustrated in FIG. 3, many other methods for carrying out the functions described herein may alternatively be used. For example, the order of execution of the blocks may be rearranged or performed in series or parallel with each other, blocks may be changed, eliminated, and/or combined to perform method 300. Further, because method 300 is disclosed in connection with the components of FIGS. 1-2 and 4, some functions of those components will not be described in detail below.

Method 300 may start at block 302. As described above, the system and method of the present disclosure may be implemented on top of a website's existing platform. This can be done, for example, through the use of APIs, cloud storage, and distributed computing for the various components of the system. The disclosed system does not need to replace existing components, but rather can be added on to provide additional functionality in the existing web platform framework.

Once implemented, the system and method of the present disclosure allows for the use of feature-based customizable models that generate an output of re-ranked search results based on the web platform's defined goal(s). At block 304, method 300 may include receiving a search query at the user device. As noted above, the user device may include a laptop, desktop, phone, tablet, or other device configured to receive input from a user. The search query may be text, images, symbols, sounds, or other information. The user device may also include user ID information, such as a user ID number, user name, account info, or other information that can be used to identify the user.

At block 306, method 300 may include passing the search query and user ID information to the search engine.

At block 308, method 300 may include retrieving search results. The search engine may receive the search query, and communicate with a memory storage to determine search results that correspond to the search query. The search results may be determined using any suitable algorithm or method.

At block 310, method 300 may include passing the search results to the augmented search system. The augmented search system may also communicate with the memory storage, the search engine, and/or an analytics source to gather information about the user, the search results, and the products available from the web platform. The augmented search system may also receive one or more goals from the web platform. At block 312, the augmented search system may run this information through a machine learning algorithm and/or artificial intelligence model to determine a re-ranked set of search results tailored to accomplish the goal(s) of the web platform. In some examples, the model or models used may be automatically selected without interaction from a human. For example, given the goal of increasing sales of a particular item, a particular model or models may be automatically selected without requiring a human to manually make a selection.

At block 314, method 300 may include passing the re-ranked results back to the search engine, and at block 316 the re-ranked results are passed on to the user device for display to the user. Method 300 then ends at block 318.

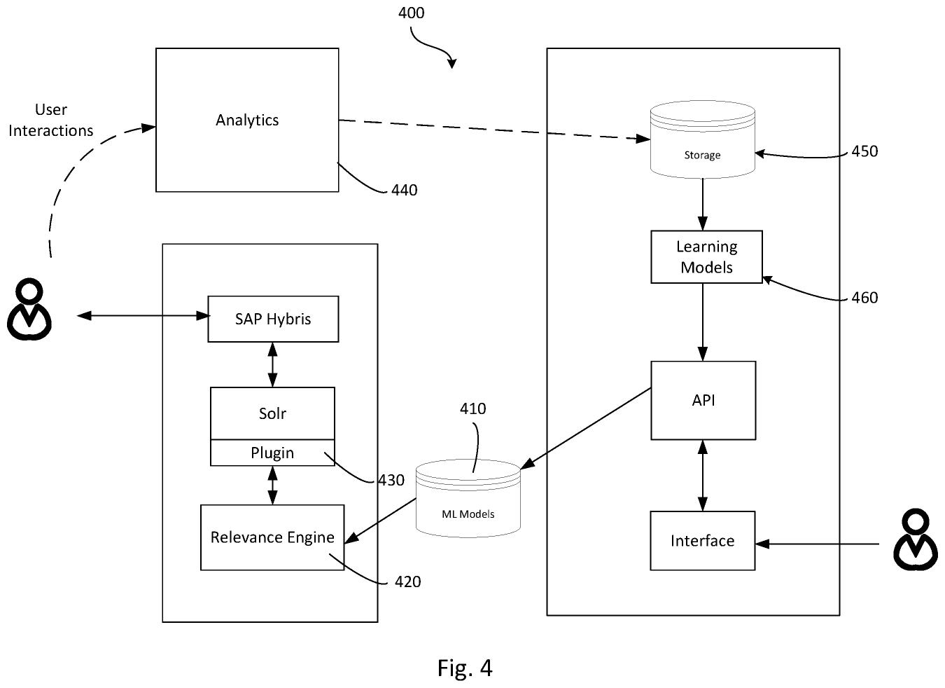

FIG. 4 illustrates an example simplified block diagram 400 of a system of the present disclosure integrated with a web platform using a plugin technique. The block diagram of FIG. 4 shows an alternative visual representation of the system as compared to the system 200 shown in FIG. 2.

In FIG. 4, the machine learning models 410 are easily accessible via an API by the inference engine 420 (which may also be referred to as the Relevance Engine 420, or augmented search system 420). As noted above, the augmented search system 420 (also shown as reference number 250 with respect to FIG. 2) is configured to determine what rankings of search results should be passed back to the search engine based on the search query and other inputs received, such as the user ID, account number, location, gender, etc. The augmented search system 420 is also responsible for determining the machine learning model 410 to be used (e.g., to optimize for purchases, clickthrough, revenue, etc.) and the model 410 parameters (e.g., ranking override rules, query targeting rules, model training schedule, etc.) that will impact the final rankings of the search results provided to the search engine.

The augmented search system 420 accesses the models, and communicates via a plugin 430 with the search engine (shown as a Solr search engine in this example). As noted above, the plugin 430 may be developed specifically for the particular search engine or web platform (e.g., Solr, Shopify, Magento, BigCommerce). A different plugin may be used for each different search engine or web platform.

The analytics platform 440 gathers information about the user, such as user interactions, demographics, location, affinities, and more. This information is then accessible via an API. FIG. 4 illustrates that one example analytics platform is Adobe Analytics. However, it should be understood that other analytics platforms maybe used as well.

The storage 450 receives data from the analytics platform 440. The data can then be used to train various machine learning models to optimize different things, and to achieve various goals.

The model optimization 460 continuously optimizes the machine learning models based on new information that is gathered from the analytics platform. In some examples, the web platform may be able to change various parameters and settings of the machine learning models to develop customized models.

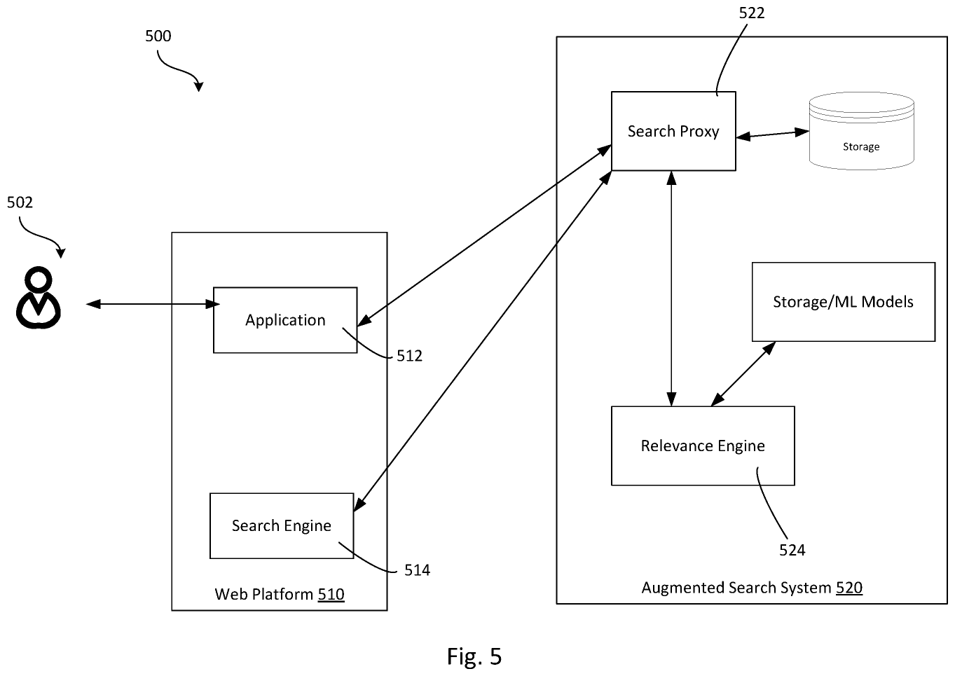

FIG. 5 illustrates an example simplified block diagram 500 of a system of the present disclosure integrated with a web platform using a reverse proxy technique. The block diagram of FIG. 5 shows an example alternative visual representation of the system as compared to the system 200 shown in FIG. 2, and the system 400 shown in FIG. 4.

In FIG. 5, a reverse proxy implementation approach is illustrated, which enables quick and easy integration with a web platform environment. This approach includes the augmented search system 520 serving as a “middleman” including a reverse proxy server that fields search requests received by the web platform 510 via the web application 512, and passes responses off to the search engine 514 of the web platform, allowing the augmented search system 520 to adjust the rankings for any results where it is enabled.

Unlike in some environments where the web platform 510 would send search requests directly to the search engine 514, with the proxy approach the web platform 510 instead is configured to send the search request to the search proxy 522, and receive search responses from the search proxy 522 for display to the user 502 instead.

Once a search request is received by the web application 512, it is sent to the search proxy 522. The search proxy 522 is configured to analyze the search request and determine if it is eligible to be updated with the augmented search system rankings. Note that this eligibility can be configured by the web platform, such that the web platform can decide when to show standard search results and rankings, and when to show the augmented search results and rankings. If the search request/query is eligible, the search proxy 522 interacts with the Relevance Engine 524 to retrieve the appropriate rankings (e.g., using any of the techniques disclosed herein, and using any relevant information) and also interacts with the search engine 514 to retrieve any other relevant search information. Once retrieved, these augmented rankings and the rest of the search request is passed back to the web platform application 512, which may then display the results to the end user 502. If the search request/query is not eligible, the search proxy 522 will simply retrieve the search results from the web platform search engine 514 and then pass the results back to the web platform application 512, which may then display the results to the end user 502.

The relevance engine 524 is configured to determine what rankings should be passed back to the web platform application 512 based on the search query and other inputs received, including any information disclosed herein such as user id, account number, location, gender, etc. The relevance engine 524 is also configured to determine which model to be used (e.g., which goal is selected, so as to optimize for purchases, clickthrough, revenue, etc.) and the model parameters (ranking override rules, query targeting rules, model training schedule, etc.) that will impact the final rankings provided.

In some examples, the use of the search proxy 522 enables re-ranked results to be determined before the web platform displays any results to the end user 502. In this way, the user is not exposed to any ranking other than the re-ranked search results.

### Improved Output and Interface

Embodiments of the present disclosure also provide the benefit of enabling the owner of the web platform or other interested parties to access and make use of the analytical data. To that end, the disclosed system may provide a web platform access and insight into the data or parameters that shaped the final rankings generated by the feature-based model of the present disclosure. This information can be used by the web platform for other decision making purposes, such as marketing, product development, etc.

Embodiments of the present disclosure provide a web platform with a variety of menus, dashboards, options, parameters, and inputs that can be used to tailor the models. For example, the web platform may be able to customize its goals using the available options and parameters, thereby generating a custom model to be used for its customers. In certain embodiments, the system and method of the present disclosure may make the rankings visible to the website owner, and allow for specific model settings for the owner to select.

In some examples, as noted above, the system of the present disclosure enables the web platform to select one or more customizable goals. These goals may be increased purchases, increased revenue, increased clickthrough, or other custom goals. Alternative solutions may only provide one or a handful of set-in-stone goals, which are not customizable by the web platform.

The system of the present disclosure also is configured such that new goals, and new corresponding machine learning or AI models can be generated and added at any time. These new goals and models can be developed over time as a given web platform develops and changes its business strategy.

While one or more specific embodiments have been illustrated and described in connection with the invention(s), it is understood that the invention(s) should not be limited to any single embodiment, but rather construed in breadth and scope in accordance with recitation of the appended claims.

What is claimed is:

1. A computer-implemented method comprising:
receiving, at a web platform, a search query from a user;
determining, by the web platform based on the search query, an initial set of search results ranked in a first order;
receiving analytics data corresponding to the user;
determining, based on a desired goal of the web platform, a target artificial intelligence model from a plurality of available artificial intelligence models;
applying the target artificial intelligence model to the search query, initial set of search results, and the analytics data to determine a re-ranked set of search results, ranked in a second order; and
providing the re-ranked set of search results, ranked in the second order, to the user.

2. The computer-implemented method of claim 1, wherein determining the initial set of search results ranked in the first order comprises determining and ranking the initial set of results based on relevance, and without using an artificial intelligence model.

3. The computer-implemented method of claim 1, wherein the analytics data corresponding to the user comprises data corresponding to past interactions of the user with the web platform.

4. The computer-implemented method of claim 1, wherein the web platform is a first web platform of a plurality of web platforms, and wherein the analytics data corresponding to the user comprises data corresponding to past interactions of the user with one or more of the plurality of web platforms other than the first web platform.

5. The computer-implemented method of claim 1, wherein the desired goal of the web platform comprises a financial objective of the web platform or an inventory-based objective of the web-platform.

6. The computer-implemented method of claim 1, wherein the desired goal is one goal of a plurality of available goals selectable by the web platform, the method further comprising:
determining a plurality of artificial intelligence models each corresponding to one of the plurality of goals.

7. The computer-implemented method of claim 1, wherein the desired goal comprises a combination of two or more of a plurality of available goals selectable by the web platform, the method further comprising:
determining a plurality of artificial intelligence models, wherein one or more of the plurality of artificial intelligence models corresponds to the combination of two or more of the available goals.

8. The computer-implemented method of claim 1, wherein determining the target artificial intelligence model comprises selecting the target artificial intelligence model from a plurality of stored artificial intelligence models.

9. The computer-implemented method of claim 1, further comprising:
developing the target artificial intelligence model based on the analytics data corresponding to the user, and based on analytics data corresponding to one or more other users.

10. The computer-implemented method of claim 1, wherein the first order is different than the second order.

11. A system comprising
a web platform configured to:
receive, from a user device, a search query;
determine, based on the search query, an initial set of search results ranked in a first order;
receive, from an augmented search system, a re-ranked set of search results; and
provide, to the user device, the re-ranked set of search results; and
an augmented search system configured to:
receive, from the web platform, the search query and the initial set of search results;
receive analytics data corresponding to the user device;
determine, based on a desired goal of the web platform, a target artificial intelligence model from a plurality of available artificial intelligence models;
apply the target artificial intelligence model to the search query, initial set of search results, and the analytics data to determine the re-ranked set of search results, ranked in a second order; and
provide, to the web platform, the re-ranked set of search results, ranked in the second order.

12. The system of claim 11, wherein the analytics data corresponding to the user device comprises data corresponding to past interactions of a user of the user device with the web platform.

13. The system of claim 11, wherein the web platform is a first web platform of a plurality of web platforms, and wherein the analytics data corresponding to the user device comprises data corresponding to past interactions of a user of the user device with one or more of the plurality of web platforms other than the first web platform.

14. The system of claim 11, wherein the desired goal of the web platform comprises a financial objective of the web platform or an inventory-based objective of the web-platform.

15. The system of claim 11, wherein the desired goal is one goal of a plurality of available goals selectable by the web platform, wherein the augmented search system is further configured to:
determine a plurality of artificial intelligence models each corresponding to one of the plurality of goals.

16. The system of claim 11, wherein the desired goal comprises a combination of two or more of a plurality of available goals selectable by the web platform, wherein the augmented search system is further configured to:
determine a plurality of artificial intelligence models, wherein one or more of the plurality of artificial intelligence models corresponds to the combination of two or more of the available goals.

17. The system of claim 11, wherein the augmented search system is further configured to:
store a plurality of stored artificial intelligence models,
wherein determining the target artificial intelligence model comprises selecting the target artificial intelligence model from the plurality of stored artificial intelligence models.

18. The system of claim 11, wherein the augmented search system is further configured to:
develop the target artificial intelligence model based on the analytics data corresponding to the user device, and based on analytics data corresponding to one or more other user device.

19. The system of claim 11, wherein the first order is different than the second order.

20. A non-transitory, computer-readable memory having instructions stored thereon that, when executed by a processor, cause the performance of a set of acts comprising:
receiving a search query from a user;
determining, based on the search query, an initial set of search results ranked in a first order;
receiving analytics data corresponding to the user;
determining, based on a desired goal, a target artificial intelligence model from a plurality of available artificial intelligence models;
applying the target artificial intelligence model to the search query, initial set of search results, and the analytics data to determine a re-ranked set of search results, ranked in a second order; and
providing the re-ranked set of search results, ranked in the second order, to the user.
